(19) United States
(12) Patent Application Publication
(10) Pub. No.: US 2016/0344126 A1
(43) Pub. Date: Nov. 24, 2016

(54) FIXED CONTACT

(71) Applicant: YAZAKI CORPORATION, Tokyo (JP)

(72) Inventors: Yoshitaka ITO, Shizuoka (JP); Takaya KONDOU, Shizuoka (JP)

(73) Assignee: YAZAKI CORPORATION, Tokyo (JP)

(21) Appl. No.: 15/227,013

(22) Filed: Aug. 3, 2016

Related U.S. Application Data
(63) Continuation of application No. PCT/JP2015/052318, filed on Jan. 28, 2015.

(30) Foreign Application Priority Data
Feb. 7, 2014 (JP) 2014-022144

(51) Int. Cl. H01R 13/03; C25D 3/30; C23C 18/54

(52) U.S. Cl. CPC H01R 13/03; C23C 18/54; C25D 3/30

(57) ABSTRACT

A fixed contact on which a moving contact slides includes a base material and a plating layer (tin: Sn etc.) for covering the base material. The base material is formed by a plate material of copper, aluminum alloy, stainless steel, or the like, that has a higher electric resistivity than the plating layer.

### CROSS REFERENCE TO RELATED APPLICATIONS

This application is a continuation of International Application No. PCT/JP2015/052318, filed Jan. 28, 2015, and based upon and claims the benefit of priority from Japanese Patent Application No. 2014-022144, filed Feb. 7, 2014, the entire contents of all of which are incorporated herein by reference.

### TECHNICAL FIELD

The present application relates to a fixed contact on which a moving contact slides.

### BACKGROUND ART

In a moving contact or a fixed contact on which the moving contact slides, its surface is frequently covered with a plating layer. Especially, it is known to plate the surface of the fixed contact with tin (Sn) for the purpose of reducing the frictional resistance between both contacts so that the moving contact can slide in relation to the fixed contact smoothly. Meanwhile, there is frequently used silver (Ag) having a lower electric resistivity than tin (Sn) for plating for the purpose of reducing the electric resistance between the moving contact and the fixed contact (see JP 2013-189680 A).

### SUMMARY

However, the plating using silver as a noble metal is accompanied with a high material cost disadvantageously. For the purpose of avoiding such a high material cost, therefore, if the electric resistance is tried to be reduced by increasing a contact area between the moving contact and the fixed contact, this attempt would cause these contacts or connectors including the contacts to be increased in size.

In the above situation, therefore, an object of the present application is to provide a fixed contact by which its electric resistance with the moving contact can be kept low without incurring an increase in cost and size.

In order to attain the above object, according to a first aspect of the present application, a fixed contact on which a moving contact slides includes a base material and a covering layer configured to cover the base material The base material is made of a material having a higher electric resistivity than the covering layer.

As the base material is higher in electric resistivity than the covering layer, the electric current flowing in the fixed contact diffuses in a wide range inside the covering layer in comparison with the inside of the base material. Thus, even if the base material is covered with not a covering layer using a noble metal exhibiting a low electric resistivity but a covering layer using a non-noble metal, the electric current flowing inside the covering layer could be diffused in a wide range, thereby allowing the electric current to flow inside the base material in a wide range as well.

Consequently, despite that the contact area of the moving contact with the fixed contact is not increased, the area of the base material allowing a flowage of electric current is enlarged while keeping the electric resistivity of the fixed contact low, thereby allowing the electric resistance (contact resistance) with the moving contact to be kept low without incurring an increase in size and cost.

The covering layer may include a plurality of layers of different materials laminated on each other. In this case, it is desirable that one layer of the plurality of layers, as coming closer to the base material, is made of a material having a higher electric resistivity than the other layer closer to the surface of the covering layer.

With such a constitution, even though a material having a large degree of electric-resistivity lowering is not used for respective layers, the area allowing a flowage of electric current in each layer is gradually enlarged to expand the area of the base material allowing the flowage of electric current largely, thereby allowing the electric resistivity to be kept low.

The covering layer may be made with use of tin (Sn).

With the fixed contact according to the aspect of the present application, it is possible to keep its electric resistance (contact resistance) with the moving contact low without incurring an increase in size and cost.

### BRIEF DESCRIPTION OF DRAWINGS

FIG. 1 is an explanatory view illustrating a fixed contact according to a first embodiment.

FIG. 2 is an explanatory view illustrating a moving contact of a first comparative example where the contact area against the fixed contact is increased.

FIG. 3 is an explanatory view illustrating a moving contact of a second comparative example where the electric resistivity of a plating layer is higher than the electric resistivity of a base material.

FIG. 4 is an explanatory view illustrating the fixed contact according to a second embodiment.

### DESCRIPTION OF EMBODIMENTS

A fixed contact according to embodiments will be described with reference to drawings below. In the embodiments, explanation is performed in an example that a large electric current of an electric vehicle (EV) or a hybrid vehicle (HEV, vehicle using both an engine and a motor generator) flows between the fixed contact and a moving contact.

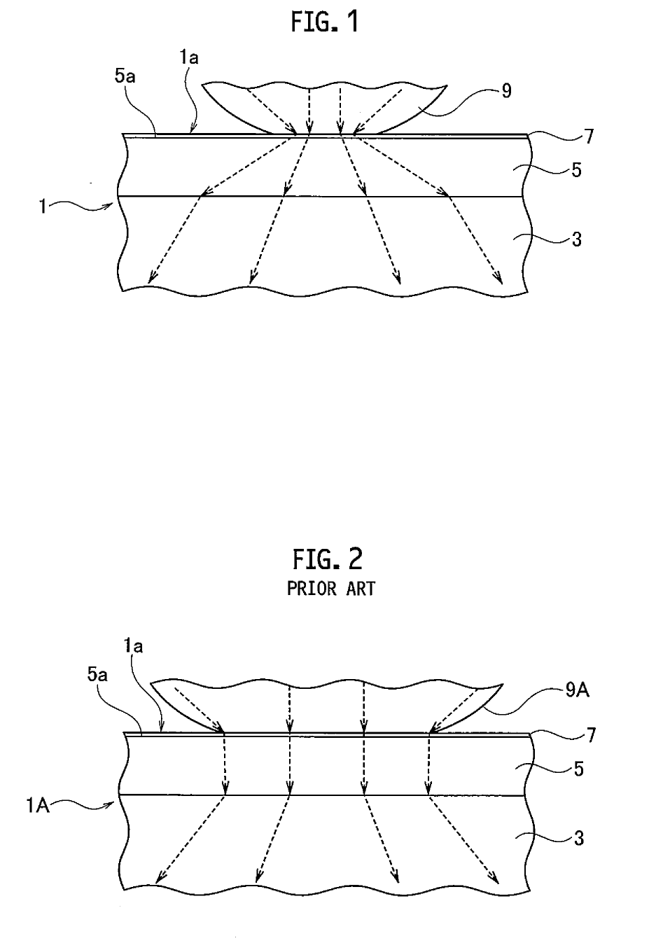

As illustrated in FIG. 1, the fixed contact 1 according to a first embodiment is constructed by covering a surface of a base material 3 with a plating layer (covering layer) 5 and also accommodated in a male connector housing (not illustrated).

A surface 5a of the plating layer 5 is covered with an oxidation resistant film 7. The oxidation resistant film 7 constitutes a sliding surface 1a of the fixed contact 1, on which a moving contact 9 accommodated in a female connector housing (not illustrated) and having an arched cross section slides at the time of fitting a male connector with a female connector.

When the electrical resistivity (volume resistivity) of the plating layer 5 is represented by “ρ”, the contact radius between the fixed contact 1 and the moving contact 1 is represented by “a”, the electrical resistivity (volume resistivity) of the oxidation resistant film 7 is represented by “pf”, and the film thickness of the oxidation resistant film 7 is represented by “d”, then the contact resistance (electric resistance) “R” between the plating layer 5 and the moving contact 9 can be represented by the following equation:

R=(ρ/2a)+pf d/πâ2.

In the fixed contact 1 according to the first embodiment, the base material 3 includes a plate material made of, for example, copper (Cu), aluminum (Al) alloy, or stainless steel, while the plating layer 5 plated on the surface of the base material 3 is made of a material having a lower electrical resistivity than the base material 3, for example, tin (Sn).

As the electrical resistivity of the base material 3 is higher than that of the plating layer 5 in the so-constructed fixed contact 1, the electrical current flowing in the fixed contact 1 diffuses in a wide range in the plating layer 5, in comparison with the range in the base material 3, as typically illustrated with dashed arrows in FIG. 1. Thus, even if there is employed not a noble metal exhibiting a low electric resistivity, such as silver (Ag), but tin (Sn) as a non-noble metal for the plating layer 5, the electric current diffuses in a wide range in the plating layer 5, thereby allowing the electric current to flow in a wide range in the base material 3 in comparison with the arrangement where the moving contact 9 slides on the base material 3 directly.

With the fixed contact 1 according to the first embodiment illustrated in FIG. 1, consequently, despite that the moving contact 9A is not constructed so as to increase its contact area with the fixed contact 1A as in the first comparative example illustrated in FIG. 2, the area of the base material 3 allowing a flowage of electric current is enlarged while keeping the electric resistivity of the fixed contact 1 low, in comparison with the fixed contact 1B comprising the plating layer 5A having a higher electric resistivity than the base material 3 as in the second comparative example illustrated in FIG. 3. Thus, it is possible to keep the electric resistance with the moving contact 9 low without incurring an increase in size and cost.

Note, in the first embodiment, the fixed contact 1 is formed with the covering layer since the plating layer 5 is formed on the surface of the base material 3. Nevertheless, as for the formation of the covering layer on the fixed contact 1, there are available other methods other than plating, for example, a vapor deposition method, a spattering method, or the like. Alternatively, the covering layer may be provided since the fixed contact includes a clad material which is obtained by bonding the base material and a thin plate having a lower electric resistivity than the base material, together.

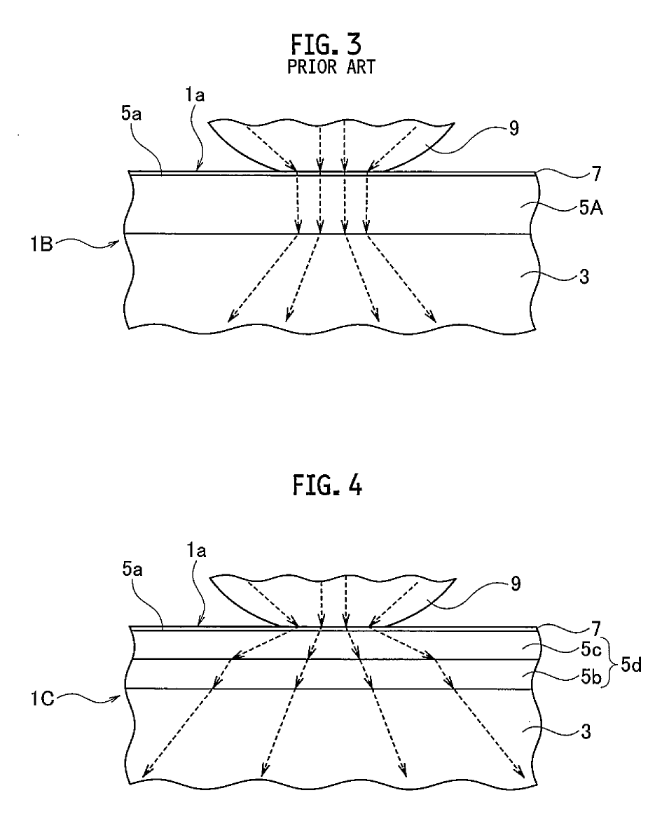

As in a fixed contact 1C according to a second embodiment, which is illustrated in FIG. 4, the plating layer (covering layer) 5 in the fixed contact 1 according to the first embodiment of FIG. 1 may be replaced with a laminating body (covering layer) 5d comprising a first layer 5b and a second layer 5c, which can be obtained by covering the surface of the base material 3 with a first layer 5b and subsequently covering the surface of the first layer 5b with a second layer 5c.

Then, for the first layer 5b, there is employed a material whose electric resistivity (volume resistivity) is lower than the base material 3. In connection, a material whose electric resistivity (volume resistivity) is lower than the first layer 5b is employed for the second layer 5c.

Thus, despite that the surface of the base material 3 is not covered with a single material having a large degree of electric-resistivity lowering in relation to that of the base material 3, the area allowing a flowage of electric current is gradually enlarged in the first layer 5b and the second layer 5c as typically illustrated with dash arrows in FIG. 4, thereby allowing the area of the base material 3 allowing the flowage of electric current to be expanded to a wide range while keeping the electric resistivity of the fixed contact 1C low.

Note, the lamination of the first layer 5b or the second layer 5c may be accomplished by means of vapor-depositing or spattering other than plating. Alternatively, the laminating body 5d, which comprises a clad material obtained by bonding the first layer 5b and the second layer 5c on each other, may be laminated on the surface of the base material 3.

In common with the first and second embodiments, additionally, although the moving contact 9 of the female connector housing is adapted so as to slide on the sliding surface 1a of the fixed contact 1, 1C accommodated in the male connector housing when fitting the male connector with the female connector, the present application is not limited to this only and therefore, the present application is widely applicable to a fixed contact having a sliding surface that a moving contact slides on.

What is claimed is:

1. A fixed contact having a plate-like shape on which a moving contact having an arched cross section slides and contacts, the fixed contact for flowing current between the moving contact and the fixed contact, comprising:
a base material;
a covering layer configured to cover the base material; and
an oxidation resistant film covering a surface of the covering layer, wherein
the base material is made of a material having a higher electric resistivity than the covering layer.

2. The fixed contact of claim 1, wherein
the covering layer comprises a plurality of layers of different materials, which are laminated on each other, and
one layer of the plurality of layers, as coming closer to the base material, is made of a material having a higher electric resistivity than the other layer closer to the surface of the covering layer.

3. The fixed contact of claim 1, wherein
the covering layer is made with use of tin.
